(19) United States
(12) Patent Application Publication
(10) Pub. No.: US 2025/0134084 A1
(43) Pub. Date: May 1, 2025

(54) OMNI-DIRECTIONAL PEST TRAP

(71) Applicant: BARN OWL TECHNOLOGIES CORP., BOSTON, MA (US)

(72) Inventors: Richard CHEN, Wellesley, MA (US); Behrooz AZIMZADEH ISMALI KANDI, Ithaca, NY (US); Scott SMITH, Cambridge, MA (US)

(73) Assignee: BARN OWL TECHNOLOGIES CORP., BOSTON, MA (US)

(21) Appl. No.: 18/924,703

(22) Filed: Oct. 23, 2024

Related U.S. Application Data
(60) Provisional application No. 63/546,174, filed on Oct. 27, 2023.

(51) Int. Cl. A01M 1/10; A01M 1/02

(52) U.S. Cl. CPC A01M 1/106; A01M 1/02; A01M 2200/012

(57) ABSTRACT

A pest trap includes a trap module and a connector module. The trap module is disposed on a columnar standing structure. The trap module includes a trap body that cooperates with an outer surrounding surface of the columnar standing structure to define an inside path therebetween for a pest to move therein. The connector module is connected to the trap module. The connector module defines a tunnel that has a first opening through which the tunnel is in spatial communication with the inside path, and that is for the pest to move therethrough. An inner surface of the trap body is at least partially slippery for the pest.

### CROSS-REFERENCE TO RELATED APPLICATION

This application claims the benefit of U.S. Provisional Patent Application No. 63/546,174, filed on Oct. 27, 2023, the entire disclosure of which is incorporated by reference herein.

### FIELD

The disclosure relates to a pest trap, and more particularly to an omni-directional pest trap.

### BACKGROUND

Plants, such as trees, may suffer from blight caused by pests. The pests may move up to the tips of the branches of the tree and lay eggs there. For example, spotted lanternfly is a pest that typically crawls on the bark (an outer layer) of a tree. Conventionally, pests may be eliminated by the use of pesticide, and the eggs of the pests may need to be manually removed. Such operations may be laborious and may not be environmentally friendly.

### SUMMARY

Therefore, an object of the disclosure is to provide a pest trap that can alleviate at least one of the drawbacks of the prior art.

According to an aspect of the disclosure, the pest trap includes a trap module and a connector module. The trap module is disposed on a columnar standing structure. The trap module includes a trap body that cooperates with an outer surrounding surface of the columnar standing structure to define an inside path therebetween for a pest to move therein. The connector module is connected to the trap module. The connector module defines a tunnel that has a first opening through which the tunnel is in spatial communication with the inside path, and that is for the pest to move therethrough. An inner surface of the trap body is at least partially slippery for the pest.

According to another aspect of the disclosure, the pest trap includes a trap module and a connector module. The trap module is disposed on a columnar standing structure. The trap module includes a trap body that cooperates with an outer surrounding surface of the columnar standing structure to define an inside path therebetween for a pest to move therein. The connector module is connected to the trap module. The connector module defines a tunnel that has a first opening through which the tunnel is in spatial communication with the inside path, and that is for the pest to move therethrough. A portion of an inner surface of the tunnel of the connector module has a texture similar to a bark of a tree.

According to still another aspect of the disclosure, the pest trap includes a trap module, a connector module and a collection module. The trap module is disposed on a columnar standing structure. The trap module includes a trap body that cooperates with an outer surrounding surface of the columnar standing structure to define an inside path therebetween for a pest to move therein. The connector module is connected to the trap module. The connector module defines a tunnel that has a first opening through which the tunnel is in spatial communication with the inside path and that is for the pest to move therethrough, and a second opening. The collection module is connected to the second opening. An inner surface of the collection module is at least partially slippery for the pest.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic side view illustrating an example omni-directional pest trap according to the disclosure.

FIG. 2 is a schematic front perspective view illustrating an example trap body of the example omni-directional pest trap.

FIG. 3 is a schematic rear perspective view illustrating the example trap body of the example omni-directional pest trap.

FIG. 4 is a perspective view illustrating an example connector module of the example omni-directional pest trap.

FIG. 5 is a sectional view illustrating an example connector module of the example omni-directional pest trap.

### DETAILED DESCRIPTION

Before the disclosure is described in greater detail, it should be noted that, where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

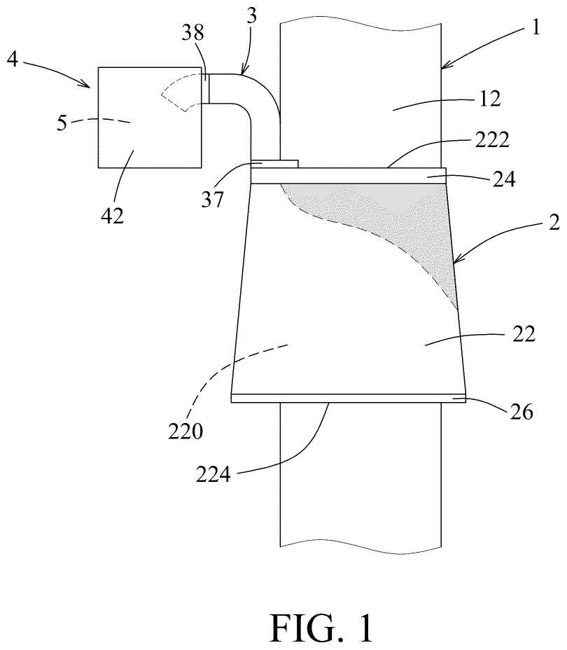

Referring to FIG. 1, an example omni-directional pest trap according to the disclosure is adapted to be disposed on a columnar standing structure to catch certain pests. The columnar standing structure may be configured as a trunk of a tree, a utility pole, a pillar, or the like. The example omni-directional pest trap may include a trap module 2 and a connector module 3.

In the illustrated examples, the trap module 2 may include a trap body 22 and a fastening mechanism 24. The trap body 22 has a first edge 222 that is distal from a ground, and a second edge 224 that is proximate to the ground. In some examples, the trap body 22 is substantially tubular, and surrounds the columnar standing structure. In some examples, the trap body 22 may be in the shape of a truncated cone that surrounds the columnar standing structure and that tapers away from the ground. In some examples, the trap body 22 may be at least partially formed from a mesh fabric. In some examples, the first edge 222 of the trap body 22 has a perimeter that is able to completely surround the columnar standing structure (i.e., completely encircles a portion of the columnar standing structure in 360 degrees). The example pest trap according to the disclosure with a trap body 22 completely surrounding the columnar standing structure serves as an omni-directional pest trap that is able to catch all the pests crawling on a portion of the columnar standing structure below the trap module 2 and moving toward the trap module 2. In some examples, the trap body 22 may not completely surround the columnar standing structure.

For different columnar standing structures having different sizes, trap bodies 22 according to the disclosure that have first edges 222 with different sizes may be provided. Therefore, a buyer is able to purchase the trap body 22 of the omni-directional pest trap with the suitable size, so as to accommodate different requirements. This design ensures that the omni-directional pest trap according to the disclosure can be used with most columnar standing structures which may be of different sizes.

When disposed on the columnar standing structure, the trap body 22 cooperates with an outer surrounding surface of the columnar standing structure to define an inside path 220 therebetween for allowing the pests to move therethrough. In some examples, an inner surface of the trap body 22 may be at least partially slippery for the pests. In some examples, the inner surface of the trap body 22 may be at least partially formed using a material that is slippery for the pests (e.g., plastic sheet/film, but not limited to such). In some examples, the inner surface of the trap body 22 may be formed by applying (e.g., coating, spraying, etc.) a slippery layer or film onto the mesh fabric that partially forms the trap body 22.

The fastening mechanism 24 may be disposed on the first edge 222 of the trap body 22. After the trap body 22 is disposed on the columnar standing structure, an operator may operate the fastening mechanism 24 to make sure that the trap body 22 is firmly fastened on the columnar standing structure. In some examples, the fastening mechanism 24 includes a cable tie that can be fastened. As such, the trap module 2 can be secured on the columnar standing structure. In some examples, the fastening mechanism 24 may include a metal wire (e.g., iron wire). In some examples, the fastening mechanism 24 may include segments of double-sided tape disposed on the inner surface of the trap body 22, so as to secure the trap body 22 onto the columnar standing structure.

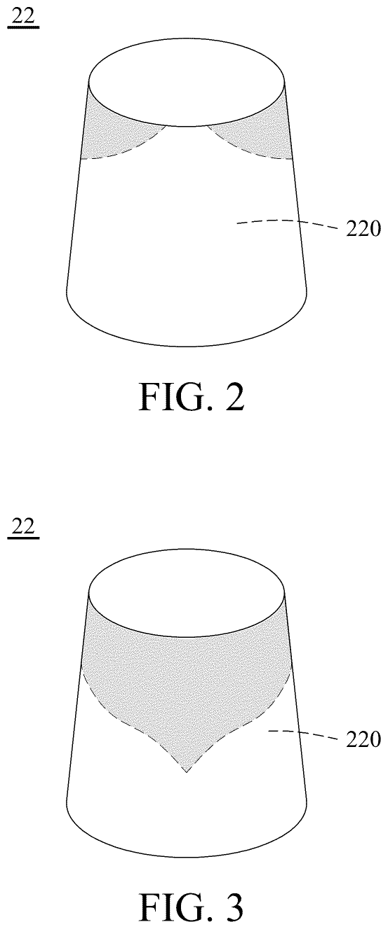

Referring further to FIGS. 2 and 3, which are respectively schematic front and rear perspective views of an example trap body 22 with the columnar standing structure being omitted, the shape of the inside path 220 may be manually adjusted such that the trap body 22 is partially in contact with the outer surrounding surface of the columnar standing structure (e.g., shaded part(s) of the trap body 22 as shown in FIGS. 1 to 3). Another portion of the trap body 22 that is spaced apart from the columnar standing structure (e.g., unshaded part(s) of the trap body 22 as shown in FIGS. 1 to 3) cooperates with the columnar standing structure to define the inside path 220. In the illustrated examples, a major portion of the first edge 222 of the trap body 22 clings to the outer surrounding surface of the columnar standing structure, and the remaining portion of the first edge 222 of the trap body 22 is spaced apart from the columnar standing structure and cooperates with the outer surrounding surface of the columnar standing structure to define an opening in which the connector module 3 is mounted. Therefore, the pests going into the inside path 220 may be limited to move in the inside path 220, may be guided to move toward the connector module 3, and cannot move up to a portion of the columnar standing structure above the fastening mechanism 24.

In some examples, the trap module 2 may further include a shaping mechanism 26 that is disposed on the second edge 224 of the trap body 20 opposite to the fastening mechanism 24. The shaping mechanism 26 may include wires made of a metal material (e.g., iron wire), and may be manually adjusted so as to shape an inlet of the inside path 220 that is defined between the second edge 224 and the columnar standing structure and that allows the pests to move into the inside path 220. By virtue of the shaping mechanism 26, the shape of the inlet of the inside path 220 may be adjusted and maintained to fit different requirements. For example, the entire second edge 224 of the trap body 22 may be spaced apart from the outer surrounding surface of the columnar standing structure, so as to prevent pests with longer legs from moving onto an outer surface of the trap body instead of into the inside path 220 as intended by design.

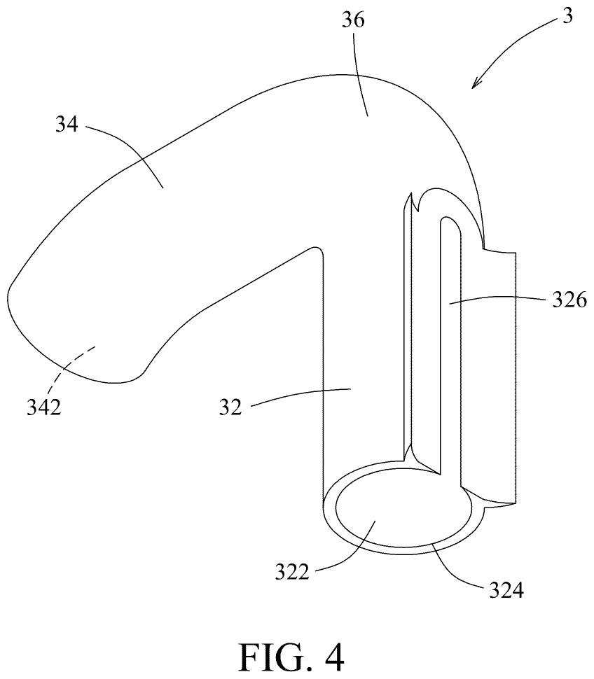

Referring further to FIG. 4, in the illustrated examples, the connector module 3 may define a tunnel 322 that has a first opening 324 through which the tunnel 322 is in spatial communication with the inside path 220, and that is for the pests to move therethrough. The connector module 3 may further define a second opening 342 through which the tunnel 322 is in spatial communication with a collection module 4 (see FIG. 1) that is connected to one side of connector module 3 opposite to the first opening 324. In some examples, the tunnel 322 of the connector module 3 may be formed to have a size that is large enough to allow a pest to move therein from the inside path 220, and yet small enough so as to not allow the pest to move back to the inside path 220 once the pest has moved to the tunnel 322. In some examples, the tunnel 322 of the connector module 3 may be tubular and may have an interior diameter ranging from 0.6 to 0.65 inches, but other sizes of the tunnel may be employed to accommodate various applications. Specifically, in some examples, for catching spotted lanternflies that are approximately 1 inch long and 0.5 inches wide at rest, the interior diameter of the tunnel 322 of the connector module 3 is about 0.6 inches. As such, the tunnel 322 is designed to have a size that allows the spotted lanternflies to move therein, while the spotted lanternflies cannot turn around or move laterally within the tunnel 322. Therefore, once the pests move into the tunnel 322 via the first opening 324, they are unable to get out of the tunnel 322 via the first opening 324.

In the illustrated examples, the connector module 3 may include a first section 32 that defines the first opening 324, a second section 34 that defines the second opening 342, and an interconnecting section 36 that interconnects the first section 32 and the second section 34. In some examples, the first section 32 may be in the shape of straight tubes. The interconnecting section 36 and the second section 34 may be in the shape of a curved tube.

With reference to FIGS. 1 and 4, in some examples, the trap body 22 may be mounted to a trunk 12 of a tree 1, and the trap body 22 cooperates with a bark of the trunk 12 to define the inside path 220 therebetween that allows the pests to move therethrough. In order to make the pests feel as if they are still moving on the bark of the tree 1 while moving in the tunnel 322, at least a portion of an inner surface of the tunnel 322 of the connector module 3 may be provided with a specific texture that is similar to the bark of the tree 1. In some examples, a portion of the inner surface of the tunnel 322 of the connector module 3 may be applied with a layer of a specific material that provides the specific texture similar to the bark of the tree 1. In some examples, the layer may be made of materials such as paper, wood, or other materials with similar tactile impressions. For example, a recycled paper may be inserted into the tunnel 322 to deceive the pests. In some examples, the inner surface of the connector module 3 itself may be partially made of the specific material that has the specific texture similar to the bark of the tree 1. In some examples, at least a portion of the inner surface of the tunnel 322 of the connector module 3 may be formed using cellulose-based compounds or wood-based compounds. In some examples, the second section 34 of the connector module 3 may be configured such that the second opening 342 opens downwardly. As such, the pests moving along the tunnel 322 to the second opening 342 may easily fall into the collection module 4 due to the force of gravity. Such a design facilitates collection of the pests.

With particular reference to FIG. 4, in some examples, the first section 32 of the connector module 3 may be formed with a groove 326 extending through an end of the first section 32 that defines the first opening 324. In use, the first section 32 may be disposed such that the first opening 324 faces downwardly and that the groove 326 is covered by the bark of the tree 1. In this example, the bark of the tree 1 may serve as a portion of the inner surface of the tunnel 322, such that the pests may move into the tunnel while still moving on the bark of the tree 1. In this example, at least a portion of the inner surface of the connector module 3 may be configured to have a specific texture similar to the bark of the tree 1.

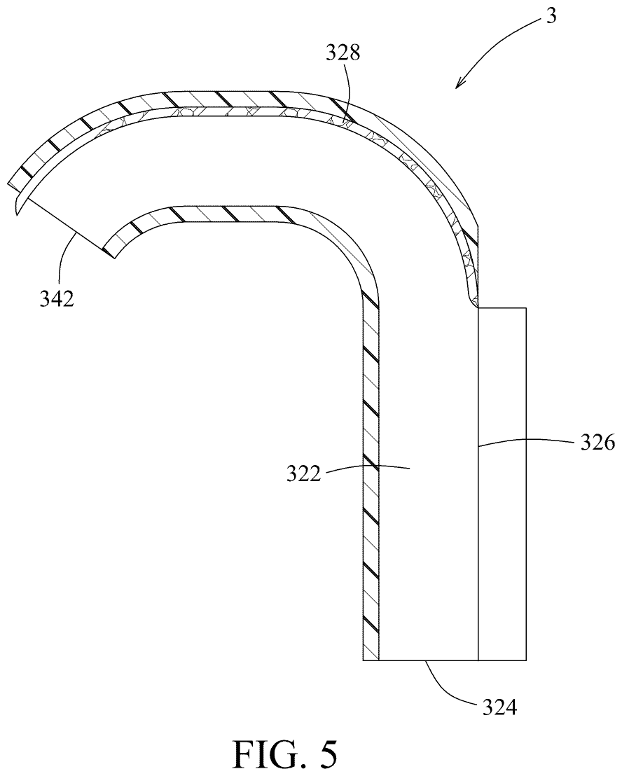

With particular reference to FIG. 5, in some examples, a guide layer 328 with the specific texture similar to the bark of the tree 1 may be attached to an upper side of the tunnel 322, and may extend from the groove 326 to the second opening 342. The guide layer 328 serves as a portion of the inner surface of the connector module 3. The other portion of the inner surface of the connector module 3 may be slippery to the pests. As such, the guide layer 328 defines a guide path that guides the pests, which enter the first opening 324 and move on a portion of the bark of the tree 1 that covers the groove 326, to move toward the second opening 342. In some examples, the guide layer 328 may have a distal portion that extends out of the second opening 342 of the connector module 3. A pest moving onto the distal portion of the guide layer 328 (i.e., moving out of the second opening 342) may be pushed by the following pests and fall into a storage, such as the collection module 4. Such a design facilitates collection of the pests. In some examples, the guide layer 328 may be made of paper, wood, or other materials with similar tactile impressions.

In some examples, a first connecting mechanism 37 may be disposed on a junction among the outer surrounding surface of the columnar standing structure, the first section 32 of the connector module 3 and the first edge 222 of the trap body 22 for sealing a gap among the columnar standing structure, the first section 32 of the connector module and the first edge 222 of the trap body 22. For example, the first connecting mechanism 37 may be embodied using a double-sided tape or other components that fasten the first edge 222 of the trap body 22 to the connector module 3 and the columnar standing structure, hence leaving no space for the pests to escape through.

In some examples, a second connecting mechanism 38 may be disposed on a junction between the connector module 3 and a portion of the collection module 4. For example, the second connecting mechanism 38 may be embodied using a zip tie, a double-sided tape or other components that fasten the connector module 3 to the collection module 4, thereby leaving no space for the pests to escape through.

In some examples, the collection module 4 may be embodied using a plastic bag, a box or other components that can contain the pests. In some examples, an inner surface of the collection module 4 may be at least partially slippery to the pests. For example, the inner surface of the collection module 4 may be formed using a component that is slippery to the pest (e.g., plastic). In some examples, the collection module 4 defines a containing space 42 that is for containing the pest, and that is located lower than the second opening 342 of the connector module 3. In such a configuration, once a pest moves into the containing space 42, it cannot move upwardly (since the inner surface of the collection module 4 is slippery to the pest) and therefore would be unable to move out of the collection module 4.

In some examples, the omni-directional pest trap may further include a luring substance 5 which may be disposed inside the collection module 4. For example, mechanically crushed leaves from “tree of heaven” (a preferred host for the spotted lanternfly), or an oil-based (or water-based) extraction of the leaves that contains plant volatile compounds may be placed inside the collection module 4 for luring the pest to move into the omni-directional pest trap. In some examples, cotton that absorbs the oil-based or water-based extraction of the leaves may be disposed inside the collection module 4 to serve as a carrier of the luring substance 5. It is noted that in other examples, other substances may be employed as the luring substance. In some examples, the luring substance may be disposed at other locations in different implementations for other purposes, such as luring the pest to move into the trap module 2 and/or the connector module 3.

One effect of the omni-directional pest trap according to the disclosure is that the trap bodies 22 with different sizes can be provided. As such, the omni-directional pest trap would be fitted and secured completely around a columnar standing structure with any diameter. When disposed on a trunk 12 of a tree 1, this design may prevent the pests on the tree from moving toward the branches of the tree past the omni-directional pest trap, particularly past the fastening mechanism 24. The design with the trap body 22 completely surrounding the trunk 12 of the tree 1 may be particularly effective in blocking the pests from moving up to the canopy of the tree to lay eggs there. As such, use of the omni-directional pest trap according to the disclosure may also be advantageous in implementing pest control, offering a cheaper and more eco-friendly alternative to the use of pesticide or manually removing the eggs on the canopy of the tree.

Moreover, having different sizes available may allow the potential buyer to purchase a suitable omni-directional pest trap for a specific columnar standing structure or a specific tree that may be infested with pests. This may therefore offer potential cost savings to buyers with pest problems when larger trees are involved.

Additionally, the material for the trap body 22, the inner surface of the tunnel 322 and the inner surface of the collection module 4 may be specifically designed such that the inner surface of the collection module 4 and the inner surface of the trap body 22 are at least partially slippery for the pests, and that at least a portion of the inner surface of the tunnel 322 may have the texture similar to the bark of the tree. As such, when a pest is lured by the luring substance 5 to move into the inside path 220 of the trap body 22 and toward the collection module 4, the pest may be unable to move on the inner surface of the trap body 22, and may be “deceived” to move into the tunnel 322, and then into the collection module 4, with a very limited chance of escape. The material used for forming an inner surface of the trap body 22 may dissuade the pest from moving directly thereon, and therefore the only desirable path is the inside path 220. The material used for the guide layer 328 (see FIG. 5) in the tunnel 322 makes the pest “think” it is still moving on the bark of the tree.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited 17 to the disclosed embodiment(s) but is intended to cover various arrangements included within the spirit and scope of the broadest interpretation so as to encompass all such modifications and equivalent arrangements.

What is claimed is:

1. A pest trap comprising;
a trap module adapted to be disposed on a columnar standing structure, the trap module including a trap body that cooperates with an outer surrounding surface of the columnar standing structure to define an inside path therebetween for a pest to move therein; and
a connector module connected to the trap module, the connector module defining a tunnel that has a first opening through which the tunnel is in spatial communication with the inside path, and that is for the pest to move therethrough;
wherein an inner surface of the trap body is at least partially slippery for the pest.

2. The pest trap as claimed in claim 1, wherein the trap body is at least partially formed from a mesh fabric, is in a shape of a truncated cone, and is adapted to completely surround the columnar standing structure.

3. The pest trap as claimed in claim 2, wherein the trap body has a first edge that is adapted to be distal from a ground, the trap module further including a fastening mechanism that is disposed on the first edge of the trap body to fasten the first edge of the trap body onto the columnar standing structure.

4. The pest trap as claimed in claim 3, wherein the fastening mechanism includes one of a double-sided tape and a metal wire.

5. The pest trap as claimed in claim 1, wherein the trap body is adapted to be partially in contact with the outer surrounding surface of the columnar standing structure, a portion of the trap body that is spaced apart from the outer surrounding surface of the columnar standing structure cooperating with the columnar standing structure to define the inside path.

6. The pest trap as claimed in claim 1, wherein the connector module further defining a second opening through which the tunnel is in spatial communication with a collection module.

7. The pest trap as claimed in claim 6, wherein the second opening of the connector module opens downwardly.

8. The pest trap as claimed in claim 6, wherein:
the connector module includes a first section that defines the first opening, a second section that defines the second opening, and an interconnecting section that interconnects the first section and the second section; and
the first section of the connector module is formed with a groove extending through an end of the first section that defines the first opening.

9. A pest trap comprising;
a trap module adapted to be disposed on a columnar standing structure, the trap module including a trap body that cooperates with an outer surrounding surface of the columnar standing structure to define an inside path therebetween for a pest to move therein; and
a connector module connected to the trap module, the connector module defining a tunnel that has a first opening through which the tunnel is in spatial communication with the inside path, and that is for the pest to move therethrough;
wherein a portion of an inner surface of the tunnel of the connector module has a texture similar to a bark of a tree.

10. The pest trap as claimed in claim 9, wherein the portion of the inner surface of the tunnel of the connector module is made of a material selected from a group consisting of paper, wood, recycled paper and materials with a texture that is similar to the bark of the tree.

11. The pest trap as claimed in claim 9, wherein:
the connector module includes a first section that defines the first opening, a second section that defines the second opening, and an interconnecting section that interconnects the first section and the second section; and
the first section of the connector module is formed with a groove extending through an end of the first section that defines the first opening.

12. The pest trap as claimed in claim 11, further comprising a guide layer that is attached to an upper side of the tunnel, that extends from the groove to the second opening, and that provides the texture similar to the bark of the tree.

13. The pest trap as claimed in claim 12, wherein the guide layer has a distal portion extending out of the second opening.

14. The pest trap as claimed in claim 9, wherein the tunnel is dimensioned to have a size that allows the pest to move thereinto while the pest is unable to turn or move laterally within the tunnel.

15. The pest trap as claimed in claim 9, wherein an interior diameter of the tunnel ranges from 0.6 to 0.65 inches.

16. The pest trap as claimed in claim 9, wherein the trap body is adapted to be partially in contact with the outer surrounding surface of the columnar standing structure, a portion of the trap body that is spaced apart from the outer surrounding surface of the columnar standing structure cooperating with the columnar standing structure to define the inside path.

17. A pest trap comprising;
a trap module adapted to be disposed on a columnar standing structure, the trap module including a trap body that cooperates with an outer surrounding surface of the columnar standing structure to define an inside path therebetween for a pest to move therein;
a connector module connected to the trap module, the connector module defining a tunnel that has a first opening through which the tunnel is in spatial communication with the inside path and that is for the pest to move therethrough, and a second opening; and
a collection module connected to the second opening;
wherein an inner surface of the collection module is at least partially slippery for the pest.

18. The pest trap as claimed in claim 17, wherein the collection module defines a containing space that is for containing the pest, and that is located lower than the second opening of the connector module.

19. The pest trap as claimed in claim 17, further comprising a luring substance for luring the pest thereinto.

20. The pest trap as claimed in claim 19, wherein the luring substance is disposed in the collection module.
